(19) United States
(12) Patent Application Publication
(10) Pub. No.: US 2026/0212716 A1
(43) Pub. Date: Jul. 23, 2026

(54) PRINTED OBJECT DELIVERY SYSTEM SERVER

(71) Applicant: TOSHIBA TEC KABUSHIKI KAISHA, Tokyo (JP)

(72) Inventors: Haru HIKITA, Mishima Shizuoka (JP); Hiroki KINOSHITA, Sunto Shizuoka (JP); Takashi UEDA, Ebina Kanagawa (JP); Satoshi OYAMA, Mishima Shizuoka (JP)

(73) Assignee: TOSHIBA TEC KABUSHIKI KAISHA, Tokyo (JP)

(21) Appl. No.: 19/443,883

(22) Filed: Jan. 8, 2026

(30) Foreign Application Priority Data
Jan. 17, 2025 (JP) 2025-006937

(51) Int. Cl. G07C 9/00; H04L 9/08

(52) U.S. Cl. CPC G07C 9/00182; H04L 9/0863

(57) ABSTRACT

According to at least one embodiment of the present disclosure, a server of a printed object delivery system that secures the confidentiality of a printed object is provided. A printed object delivery system server includes a communication interface and a processor. The communication interface communicates with a first terminal, a second terminal, and an image forming device. The processor acquires user information from the first terminal, acquires document information from the first terminal, and acquires storage box information about a storage box from the image forming device. The processor requests the image forming device to perform printing based on the document information, and transmits delivery destination information based on the user information, and the storage box information, to the second terminal after receiving a signal indicating completion of printing from the image forming device.

### CROSS-REFERENCE TO RELATED APPLICATION

This application is based upon and claims the benefit of priority from Japanese Patent Application No. 2025-006937, filed on January 17, 2025, the entire contents of which are incorporated herein by reference.

### FIELD

Embodiments described herein relate generally to a printed object delivery system server.

### BACKGROUND

Related printed objected delivery systems may receive a print request online from a user, perform printing based on a requested document, and deliver a printed object to the user’s home. However, such systems suffer from confidentiality issues including the content of the printed object being exposed due to human involvement in the process after printing. An additional challenge is that the sender must invest time and effort in collecting and preparing the printed object for delivery.

### DESCRIPTION OF THE DRAWINGS

FIG. 1 is a block diagram showing a configuration example of a printed object delivery system.

FIG. 2 is a block diagram showing a configuration example of the system.

FIG. 3 is a schematic view showing an example of the hardware configuration of an image forming device and a storage box.

FIG. 4 is a table showing an example of a user information database provided in a memory of a server.

FIG. 5 is a table showing an example of an image forming device information database provided in the memory.

FIG. 6 is a table showing an example of a delivery person terminal information database provided in the memory.

FIG. 7 is a table showing an example of a request information storage provided in the memory.

FIG. 8 shows an outline of a printed object delivery flow in the system.

FIG. 9 shows an outline of the flow.

### DETAILED DESCRIPTION

The systems and methods of the present disclosure include a server of a printed object delivery system that maintains and secures the confidentiality of a printed object.

In one or more embodiments, a printed object delivery system server includes a communication interface (e.g., communicator) and a processor. The communication interface communicates with a first terminal, a second terminal, and an image forming device. The processor acquires user information from the first terminal, acquires document information from the first terminal, and acquires storage box information about a storage box from the image forming device, the storage box storing a printed object printed by the image forming device, including a locking mechanism for locking the storage box, and being attachable to and detachable from the image forming device. The processor requests the image forming device to perform printing based on the document information, and transmits delivery destination information based on the user information, and the storage box information, to the second terminal after receiving a signal indicating completion of printing from the image forming device.

A printed object delivery system 1 will now be described with reference to the drawings.

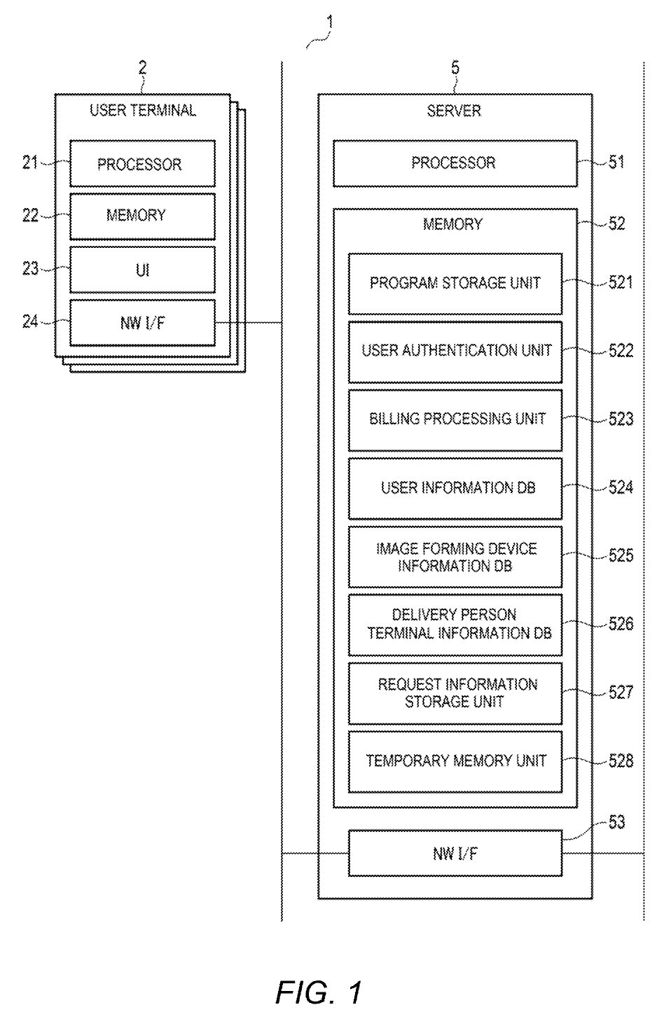

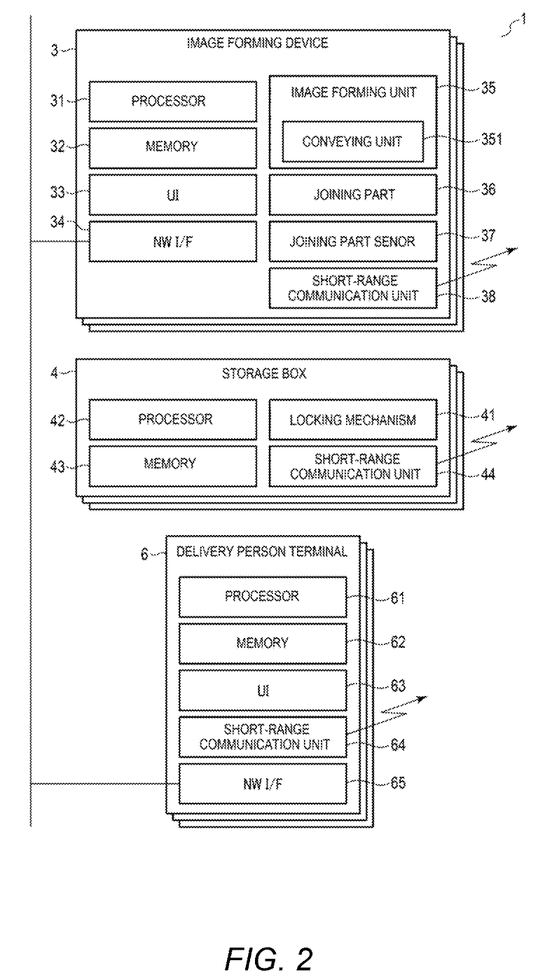

FIGS. 1 and 2 are schematic views showing a configuration example of the printed object delivery system 1 according to an embodiment. The printed object delivery system 1 can include a user terminal 2 (e.g., first terminal), an image forming device 3, a storage box 4, a server 5, and a delivery person terminal 6 (e.g., second terminal). The user terminal 2 and the server 5 can be communicably connected via a network. The server 5, the image forming device 3, and the delivery person terminal 6 can be communicably connected via a network. The image forming device 3 and the storage box 4 can be communicably connected via a short-range communication technology. The storage box 4 and the delivery person terminal 6 can be communicably connected via a short-range communication technology.

The user terminal 2 will now be described. The user terminal 2 can be a terminal operated by a user using the printed object delivery system 1. The user terminal 2 is, for example, a desktop personal computer, a laptop personal computer, a smartphone, a tablet, or the like. In this embodiment, the user terminal 2 is described as a desktop personal computer.

The user terminal 2 includes, for example, a processor 21, a memory 22, a user interface 23, and a network interface 24. In FIGS. 1 and 2, the user interface is abbreviated as UI, and the network interface is abbreviated as NW I/F. The processor 21, the memory 22, the user interface 23, and the network interface 24 can be contained in a housing, which is not illustrated.

The processor 21 can be an arithmetic element that executes arithmetic processing (e.g., a computer processing unit (CPU)). The processor 21 can perform various kinds of processing, based on data of a program or the like stored in the memory 22. The processor 21 can execute a program stored in the memory 22 and thus functions as a control unit (e.g., controller) that can execute various operations.

The memory 22 can be a memory device that stores a program and data used for the program, and the like. The memory 22 can also temporarily store data that is currently being processed by the processor 21. The memory 22 can be configured as a non-volatile memory and a volatile memory.

The user interface 23 can include a display and an operation interface, which is not illustrated. The display can display a screen according to a video signal that is input from the processor 21. For example, the display can display a screen for entering user information for user authentication in the printed object delivery system 1. The operation interface can provide an operation signal corresponding to an operation of an operation member to the processor 21. The operation member is, for example, a touch sensor, a microphone, a numeric keypad, various function keys, a keyboard, or a mouse or the like. The touch sensor is, for example, a resistive touch sensor or a capacitive touch sensor or the like. The touch sensor can acquire information indicating a position designated in a given area. The touch sensor can be configured as a touch panel integrated with a display and thus inputs a signal indicating a position touched on the screen displayed on the display, to a system controller.

The network interface 24 is an interface for communicating with the server 5 via a network.

The image forming device 3 will now be described. The image forming device 3 is, for example, a multi-function printer (MFP) that performs various processing such as image forming while conveying a print medium. The image forming device 3 is, for example, a solid-state-scanning-type printer (e.g., an LED printer) that uses an LED array for scanning and performs various processing such as image forming while conveying a print medium. The image forming device 3 may also be an inkjet-type printer (e.g., inkjet printer) that uses an inkjet head that ejects ink for scanning, or a printer of another type.

The image forming device 3, for example, electrically charges a photoconductive drum, irradiates the photoconductive drum with light corresponding to image data for printing, and thus forms an electrostatic latent image on the photoconductive drum. The image forming device 3 can cause a toner to adhere to the latent image formed on the photoconductive drum, transfer the toner adhering to the latent image onto a print medium, and thus form a toner image on the print medium. The image forming device 3 can also apply heat and pressure to the print medium with the toner image transferred thereto, and thus fix the toner image to the print medium.

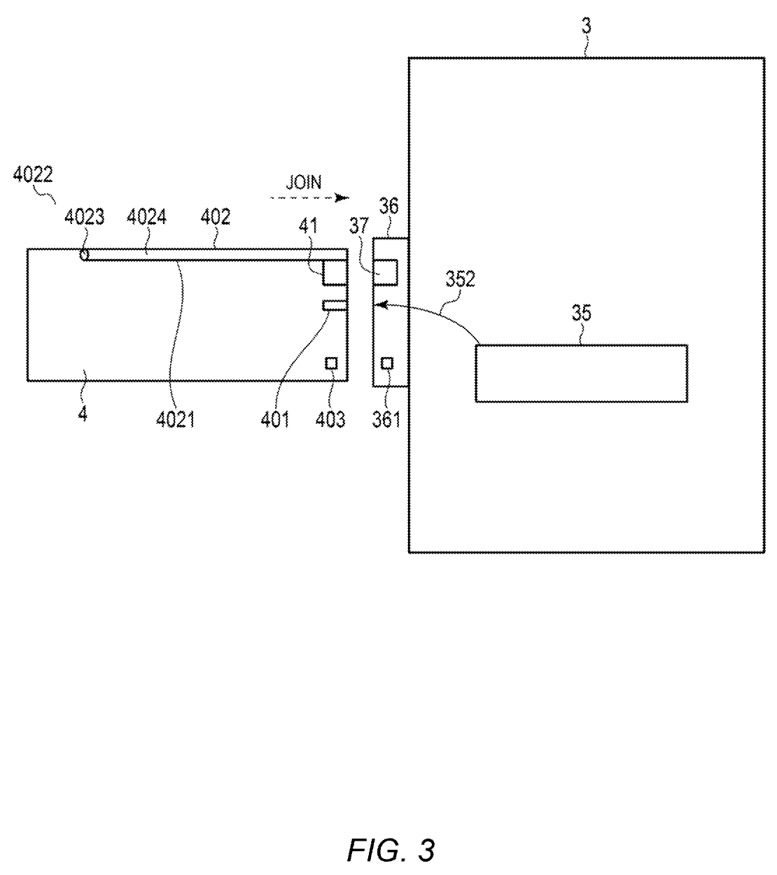

The image forming device 3 can include a processor 31, a memory 32, a user interface 33, a network interface 34, an image forming unit 35 (e.g., image former), a conveying unit 351 (e.g., conveyer), a joining part 36, a joining part sensor 37, and a short-range communication unit 38 (e.g., short-range communicator). The processor 31, the memory 32, the user interface 33, the network interface 34, the image forming unit 35, the joining part 36, the joining part sensor 37, and the short-range communication unit 38 can be contained in a housing illustrated in FIG. 3.

The processor 31 can be an arithmetic element that executes arithmetic processing (e.g., a CPU). The processor 31 can perform various kinds of processing, based on data of a program or the like stored in the memory 32. The processor 31 can execute a program stored in the memory 32 and thus function as a control unit that can execute various operations.

The memory 32 is a memory device that stores a program and data used for the program, and the like. The memory 32 can also temporarily store data that is currently being processed by the processor 31. The memory 32 can be configured as a non-volatile memory and a volatile memory.

The user interface 33 can include a display and an operation interface, which is not illustrated. The user interface 33 can supply an operation signal corresponding to an operation of a user using the image forming device 3, to the processor 31. The display can display a screen according to a video signal that is input from the processor 31. The operation interface can supply an operation signal corresponding to an operation of an operation member to the processor 31. The operation member is, for example, a touch sensor, a microphone, a numeric keypad, various function keys, or a keyboard or the like. The touch sensor is, for example, a resistive touch sensor or a capacitive touch sensor or the like. The touch sensor can acquire information indicating a position designated in a given area. The touch sensor can be configured as a touch panel integrated with a display and thus inputs a signal indicating a position touched on the screen displayed on the display, to a system controller.

The network interface 34 is an interface for communicating with the server 5 via a network.

The image forming unit 35 can form an image based on document information on the surface of a print medium under the control of the processor 31. The print medium is, for example, a standard-size print sheet, a roll paper, an RFID medium with a built-in RFID tag, a film, or the like.

The image forming unit 35 includes, for example, a process unit, an exposure device, a transfer mechanism (e.g., transfer device, etc.), a fixing device, and the conveying unit 351.

The process unit (e.g., processor) can include a photoconductive drum, an electrification charger, and a developing device. The photoconductive drum can be a photoconductor including a cylindrical drum and a photoconductive layer formed on the outer circumferential surface of the drum. The photoconductive drum can be rotated at a predetermined speed by a drive mechanism (e.g., driver), which is not illustrated.

The electrification charger can electrically charge the surface of the photoconductive drum uniformly. For example, the electrification charger can apply a voltage to the photoconductive drum, using a charging roller, and thus electrically charge the photoconductive drum with a uniform electric potential of negative polarity.

The developing device is a device that causes a toner to adhere to the photoconductive drum. The developing device can include a developer container, a stirring mechanism (e.g., stirrer), a developing roller, and a doctor blade or the like. The developer container can be a container that receives and contains a toner fed from a toner cartridge. A carrier can be contained in the developer container in advance. As the toner fed from the toner cartridge is stirred with the carrier by the stirring mechanism, a developer, which is a mixture of the toner and the carrier, can be thus formed. The carrier can be contained in the developer container when the developing device is manufactured. The developing roller rotates inside the developer container and thus can cause the developer to adhere to the surface thereof. The doctor blade can be a member arranged with a predetermined spacing from the surface of the developing roller. The doctor blade can remove a part of the developer adhering to the surface of the rotating developing roller. Thus, a layer of the developer with a thickness corresponding to the spacing between the doctor blade and the surface of the developing roller can be formed on the surface of the developing roller.

The exposure device includes a plurality of light-emitting elements. The exposure device irradiates the electrically charged photoconductive drum with light from the light-emitting elements and thus can form a latent image on the photoconductive drum. The light-emitting elements are, for example, light-emitting diodes (LEDs) or the like. One light-emitting element can be configured to irradiate one point on the photoconductive drum with light. The plurality of light-emitting elements can be arrayed in a main scanning direction, which is a direction parallel to the axis of rotation of the photoconductive drum. The exposure device can irradiate the photoconductive drum with light from the plurality of light-emitting elements arrayed in the main scanning direction and thus form a latent image for one line on the photoconductive drum. Also, the exposure device can continuously irradiate the rotating photoconductive drum with light and thus form a latent image for a plurality of lines.

In the above configuration, as the surface of the photoconductive drum electrically charged by the electrification charger is irradiated with the light from the exposure device, an electrostatic latent image can be formed. As the layer of the developer formed on the surface of the developing roller comes close to the surface of the photoconductive drum, the toner contained in the developer can adhere to the latent image formed on the surface of the photoconductive drum. Thus, a toner image can be formed on the surface of the photoconductive drum.

The transfer mechanism can be configured to transfer the toner image formed on the surface of the photoconductive drum to a print medium. The transfer mechanism can include a primary transfer belt, a secondary transfer roller, and a plurality of other rollers. In the transfer mechanism, the outer circumferential surface of the primary transfer belt receives the toner image formed on the surface of the photoconductive drum. The transfer mechanism can convey the toner image on the outer circumferential surface of the primary transfer belt to a transfer nip where the secondary transfer roller and the outer circumferential surface of the primary transfer belt are in tight contact with each other. The transfer mechanism can pass the print medium supplied by the conveying unit 351 (e.g., conveyer) through the transfer nip and thus transfer the toner image on the outer circumferential surface of the primary transfer belt to the surface of the print medium.

The fixing device can be configured to fix the toner image transferred to the surface of the print medium, to the surface of the print medium. The fixing device can include a heating member (e.g., heat roller) that applies heat to the print medium, a pressurizing member (e.g., press roller) that applies pressure to the print medium, and a heater that heats the heat roller. The press roller can apply pressure to the heat roller and thus form a fixing nip where the press roller and the heat roller are in tight contact with each other. The fixing device can pass the print medium with the toner image transferred thereto by the transfer mechanism, through the fixing nip, and thus apply heat and pressure to the print medium. Thus, the fixing device can fix the toner image formed on the surface of the print medium.

The conveying unit 351 can supply print media contained in a container unit, which is not illustrated, that includes print media, one by one, to the transfer mechanism and the fixing device, and stores a print medium with an image formed thereon into the storage box 4 outside the housing via a conveyance path 352 and the joining part 36.

FIG. 3 is a schematic view showing an example of the configuration of the image forming device 3 and the storage box 4.

The joining part 36 is a mechanism to be mechanically joined to the storage box 4. The joining part sensor 37 can detect the storage box 4 joined to the joining part 36. The joining part 36 can be configured such that the storage box 4 cannot be detached from the image forming device 3 until the conveyance of a printed object is completed after the image forming device 3 starts printing. The joining part 36 can include a protrusion 361 that can be mechanically pushed in and pulled out, and the protrusion 361 can be configured to engage with a hole 403 provided in the storage box 4. The image forming device 3 can cause the protrusion 361 of the joining part 36 to protrude before printing is started and pulls back the protrusion 361 when the conveyance of the printed object is completed. Alternatively, the image forming device 3 may be configured to stop the printing and the conveyance of the printed object and transmit an error notification to the server 5, if the storage box 4 is detached before the conveyance of the printed object in the image forming device 3 is completed.

The short-range communication unit 38 (e.g., short-range communicator) can be an interface for communicating with the storage box 4. The short-range communication unit 38 is, for example, a short-range wireless communication device using Bluetooth (trademark registered), NFC (near-field communication), or the like.

The storage box 4 will now be described. The storage box 4 can be a box that stores a printed object conveyed from the image forming device 3 and includes a locking mechanism 41 (e.g., lock). The storage box 4 can be attachable to and detachable from the image forming device 3 and can be detached from the image forming device 3 in a state of storing a printed object requested by the user and delivered to a delivery destination by a delivery person. When the storage box 4 is delivered, the user can unlock the storage box 4 with a key and collect the stored printed object. The storage box 4 from which the printed object is collected, for example, by the delivery person on the spot. The key can be information used for unlocking the storage box 4. The key is, for example, a password. The key can be described as a password.

The housing of the storage box 4 is in can be an opaque color and therefore the content of the printed object stored in the storage box 4 cannot be viewed from outside. A storage box ID can be imprinted on the housing of the storage box 4. The storage box ID can be information for uniquely identifying the storage box 4.

The storage box 4 includes, for example, an inlet port 401, an unboxing opening 402, the locking mechanism 41, a processor 42, a memory 43, and a short-range communication unit 44 (e.g., short-range communicator).

The inlet port 401 can be provided so as to be joined to the joining part 36 of the image forming device 3 and accept, into the storage box 4, a printed object conveyed from the image forming device 3 via the conveyance path 352. The inlet port 401 is, for example, provided with a guard formed of a fiber bundle toward the inside of the storage box 4 and thus has a structure such that the printed object conveyed from the image forming device 3 cannot be taken out of the storage box 4 through the inlet port 401.

The unboxing opening 402 can be configured with an opening 4021 in the housing through which the printed object stored in the storage box 4 can be taken out, and a closing member 4022 that closes the opening 4021. The storage box 4 can include, for example, a top plate 4024 that pivots about a pivot axis 4023, as the closing member 4022. The storage box 4 can be configured such that the unboxing opening 402 is not opened if the storage box 4 is joined to the image forming device 3. For example, if the storage box 4 is joined to the image forming device 3, one end of the top plate 4024 on the joining part 36 side (one end of the top plate 4024 that is not on the pivot axis 4023 side) is retained by the joining part 36 so that the top plate 4024 does not pivot.

The locking mechanism 41 can be a mechanism for regulating the opening of the unboxing opening 402. The locking mechanism 41 is, for example, an electronic lock that is physically locked so as to disable the opening of the unboxing opening 402 upon receiving a locking signal and is physically unlocked so as to enable the opening of the unboxing opening 402 upon receiving an unlocking signal.

The processor 42 can be an arithmetic element that executes arithmetic processing (e.g., a CPU). The processor 42 performs various kinds of processing, based on data of a program or the like stored in the memory 43. The processor 42 can execute a program stored in the memory 43 and thus functions as a control unit that can execute various operations.

The memory 43 can be a memory device that stores a program and data used for the program, and the like. The memory 43 can also temporarily store data that is currently being processed by the processor 42. The memory 43 can be configured as a non-volatile memory and a volatile memory. The memory 43 can store the storage box ID of the storage box 4.

The short-range communication unit 44 (e.g., short-range communicator) can be an interface for communicating with the image forming device 3 or the delivery person terminal 6. The storage box 4 can transmit the storage box ID to the image forming device 3 via the short-range communication unit 44. The storage box 4 can receive a locking signal from the image forming device 3 via the short-range communication unit 44. The storage box 4 can receive an unlocking signal from the delivery person terminal 6 via the short-range communication unit 44.

The storage box 4 may also have a wireless tag and the storage box ID may be stored on the wireless tag instead of the memory 43. The image forming device 3 can read the storage box ID of the storage box 4, for example, with a wireless tag reader.

The image forming device 3 may be provided with a plurality of joining parts 36 and may be thus configured such that a plurality of storage boxes 4 can be joined to one image forming device 3. With such a configuration, one image forming device 3 can accept a plurality of requests at a time.

The server 5 will now be described. The server 5 can be connected to a network and can communicate with the user terminal 2, the image forming device 3, and the delivery person terminal 6 via the network. The server 5 can include a processor 51, a memory 52, and a network interface 53.

The processor 51 can be an arithmetic element that executes arithmetic processing (e.g., a CPU). The processor 51 can perform various kinds of processing, based on data of a program or the like stored in the memory 52. The processor 51 can execute a program stored in the memory 52 and thus functions as a control unit that can execute various operations.

The memory 52 can be a memory device that stores a program and data used for the program, and the like. The memory 52 can also temporarily store data that is currently being processed by the processor 51. The memory 52 can be configured as a non-volatile memory and a volatile memory.

The memory 52 can include a program storage unit 521 (e.g., program storage), a user authentication unit 522 (e.g., user authenticator), a billing processing unit 523 (e.g., billing processor), a user information database 524, an image forming device information database 525, a delivery person terminal information database 526, a request information storage unit 527 (e.g., request information storage), and a temporary memory unit 528 (e.g., temporary memory). In FIG. 1, the database is abbreviated as DB. The program storage unit 521, the user authentication unit 522, the billing processing unit 523, the user information database 524, the image forming device information database 525, the delivery person terminal information database 526, and the request information storage unit 527 can be configured in the non-volatile memory, and the temporary memory unit 528 can be configured in the volatile memory. The temporary memory unit 528 can be used for temporarily storing various data and information generated by the processor 51 during processing.

The program storage unit 521 can store a program for causing the processor 51 to perform operations as a printed object delivery system server.

The user authentication unit 522 can receive information for a user to log in, and executes user authentication processing and registers information of a newly registered user. The user authentication unit 522, for example, can receive a user ID and a password supplied thereto, and execute user authentication processing with reference to user information stored in the user information database 524 and register user information of a newly registered user in the user information database 524.

The billing processing unit 523 can perform billing processing such as billing calculation and billing information notification based on a predetermined billing program. The billing processing unit 523 performs billing, for example, by any method registered by the user. The billing method may be, for example, a method using electronic money, a method of debiting from the user’s account, or a prepaid method in which billing is performed in advance. The billing method is not limited to these examples and may be any method.

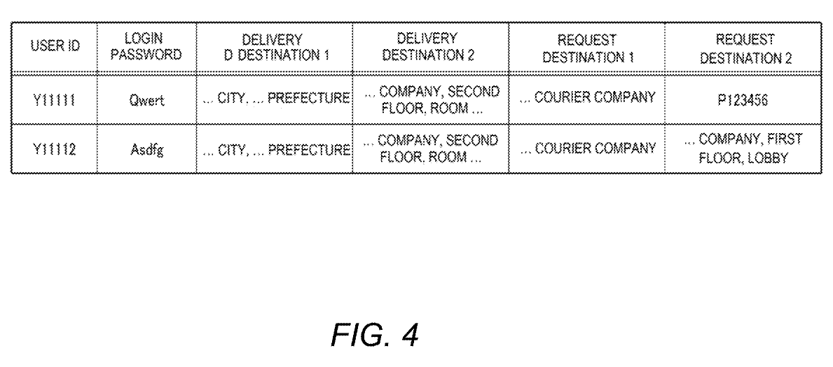

The user information database 524 can store user information, which is information about the user of the printed object delivery system 1. FIG. 4 illustrates an example of the user information stored for each user in the user information database 524. A record includes a user ID, a password, a delivery destination, and a request destination.

The user ID can be identification information that uniquely identifies the user. The user ID can be used in user authentication when the user logs in to use the printed object delivery system 1. The user ID can be automatically generated by the processor 51 and added to the record in the user information database 524 when the user is newly registered as the user of the printed object delivery system 1.

The login password can be a password used in user authentication when the user logs in to use the printed object delivery system 1. As the login password, information set by the user can be added to the record in the user information database 524.

The delivery destination can be information indicating the place to which the storage box 4 is to be delivered. The delivery destination is, for example, the user’s home address, workplace address or the like. A plurality of delivery destinations may be stored in the user information database 524. The delivery destination may be set on a per document-to-be-printed basis. In response to a plurality of delivery destinations are stored in the user information database 524, one delivery destination may be set as a basic delivery destination. With respect to a document for which a delivery destination is not set, the information set as the basic delivery destination can be reflected as the delivery destination. As the delivery destination, information set by the user can be added to the record in the user information database 524.

The request destination can be information indicating the place or device where the printed object is printed. The request destination is, for example, the image forming device ID of the image forming device 3 supported by the printed object delivery system 1, the place of installation of the image forming device 3, the address of a business operator supported by the printed object delivery system 1, or the like. A plurality of request destinations may be stored in the user information database 524. The request destination may be set on a per document-to-be-printed basis. In response to a plurality of request destinations are stored in the user information database 524, one request destination may be set as a basic request destination. With respect to a document for which a request destination is not set, the information set as the basic request destination may be reflected as the request destination. As the request destination, information set by the user can be added to the record in the user information database 524.

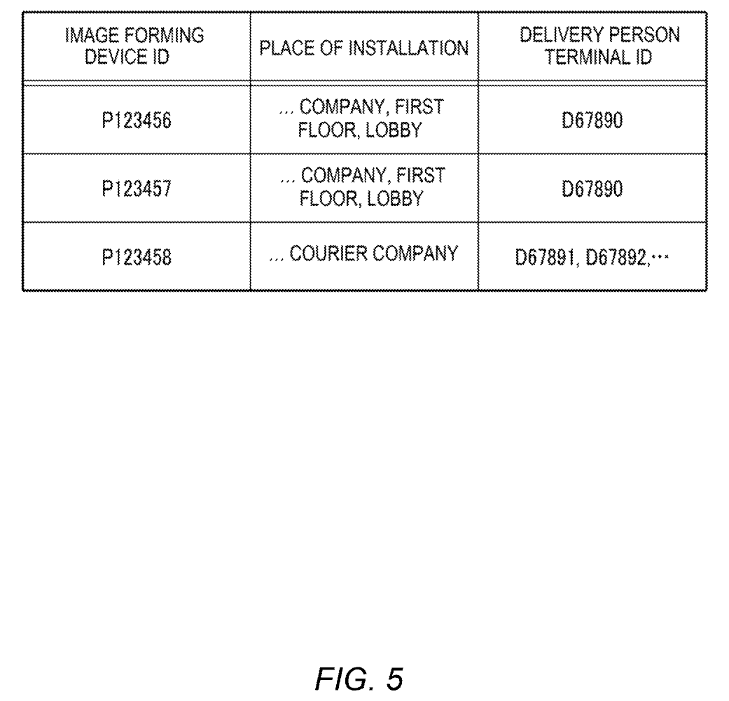

The image forming device information database 525 can store image forming device information, which can be information about the image forming device 3 in the printed object delivery system 1. FIG. 5 illustrates the image forming device information stored on a per image forming device basis in the image forming device information database 525. The record includes an image forming device ID, a place of installation, and a delivery person terminal ID.

The image forming device ID can be identification information that uniquely identifies the image forming device 3. The image forming device ID can be automatically generated by the processor 51 and added to the record in the image forming device information database 525, for example, when the manager of the image forming device 3 registers a suitable image forming device 3 as the image forming device 3 in the printed object delivery system 1.

The place of installation can be information indicating the place where the image forming device 3 is installed. The place of installation can be the place where the image forming device 3 is installed, the address of a business operator supported by the printed object delivery system 1, or the like. As the place of installation, for example, information set by the manager of the image forming device 3 is added to the record in the image forming device information database 525.

The delivery person terminal ID can be identification information that uniquely identifies the delivery person terminal 6. In the image forming device information database 525, a plurality of delivery person terminals IDs may be linked to one image forming device ID. As the delivery person terminal ID, for example, information set by the manager of the image forming device 3 is added to the record in the image forming device information database 525.

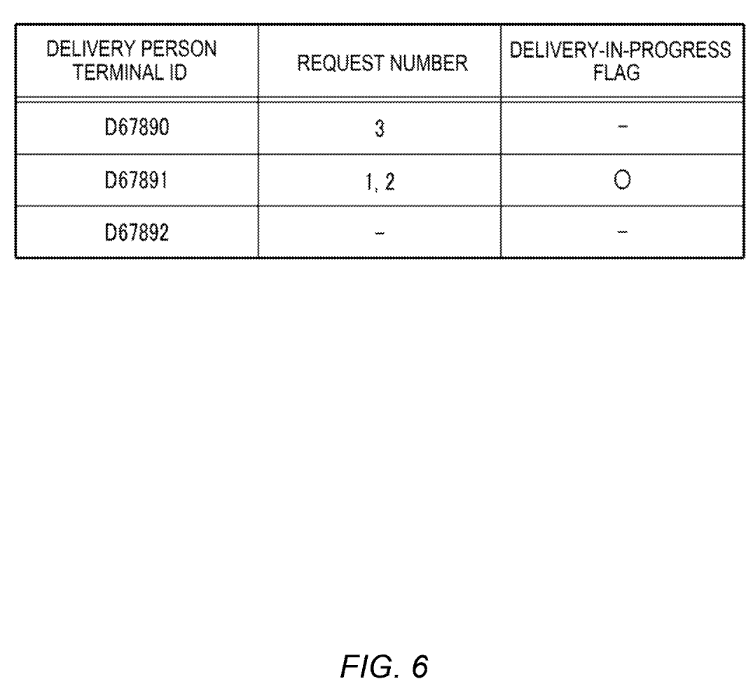

The delivery person terminal information database 526 stores delivery person terminal information, which can be information about the delivery person terminal 6 in the printed object delivery system 1. FIG. 6 illustrates an example of the delivery person terminal information stored on a per delivery person terminal basis in the delivery person terminal information database 526. The record includes a delivery person terminal ID, a request number, and a delivery-in-progress flag.

The delivery person terminal ID can be automatically generated by the processor 51 and added to the record in the delivery person terminal information database 526, for example, when the manager of the image forming device 3 registers a suitable terminal as the delivery person terminal 6 in the printed object delivery system 1.

The request number can be identification information for uniquely identifying a delivery request of the storage box 4. The user may be enabled to check the delivery status of the storage box 4 by searching for the request number after logging in. The request number can be added to the record in the delivery person terminal information database 526 with reference to the request information storage unit 527 (e.g., request information storage), for example, when the delivery request is transmitted from the server 5 to the delivery person terminal 6.

The delivery-in-progress flag can be a flag that is set when the delivery person starts delivering the storage box 4. In response to the delivery-in-progress flag being set, the delivery person terminal 6 having the corresponding delivery person terminal ID may be set such that the level of priority at which the delivery request is transmitted from the server 5 is lowered.

The delivery-in-progress flag can be added to the record in the delivery person terminal information database 526 by the delivery person, for example, when the delivery person starts delivering the storage box 4.

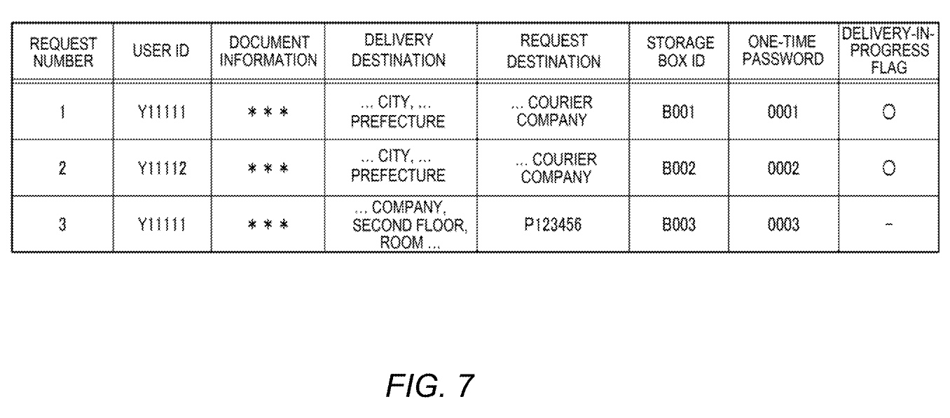

The request information storage unit 527 can store request information, which is information about a request in the printed object delivery system 1. FIG. 7 illustrates an example of the request information stored on a per request basis in the request information storage unit 527. The record includes a request number, a user ID, document information, a delivery destination, a request destination, a storage box ID, a one-time password, and a delivery-in-progress flag.

The request number can be automatically generated by the processor 51 and added to the record in the request information storage unit 527, for example, when billing processing is completed.

The user ID can be added to the record in the request information storage unit 527 with reference to the user information database 524 by the processor 51, for example, when billing processing is completed.

The document information can be information about an image to be formed on a print medium by the image forming device 3. The document information can include image data, the size, the number of copies, the print surface, the color setting, or the like of a document to be printed. The document information may include a plurality of data files. The document information can be transmitted to the server 5 by the user. The document information can be added to the record in the request information storage unit 527 by the processor 51, for example, in response to billing processing being completed.

As the delivery destination, information based on an input by the user can be added to the record in the request information storage unit 527, for example, when billing processing is completed. Alternatively, the delivery destination can be added to the record in the request information storage unit 527 with reference to the user information database 524 by the processor 51 when billing processing is completed.

As the request destination, information based on an input by the user can be added to the record in the request information storage unit 527, for example, when billing processing is completed. Alternatively, the request destination can be added to the record in the request information storage unit 527 with reference to the user information database 524 by the processor 51 when billing processing is completed.

The storage box ID can be added to the record in the request information storage unit 527 by the processor 51, for example, when the server 5 receives a signal permitting the printing and including the storage box ID from the image forming device 3.

The one-time password can be a unique password generated by the processor 51. The one-time password can be automatically generated by the processor 51 and added to the record in the request information storage unit 527 when the document information and the delivery destination transmitted from the user are registered as the record in the request information storage unit 527.

The delivery-in-progress flag can be added to the record in the request information storage unit 527 by the processor 51, for example, when information is added to the record of the delivery-in-progress flag in the delivery person terminal information database 526.

The network interface 53 can be an interface for communicating with the user terminal 2, the image forming device 3, and the delivery person terminal 6 via a network.

The delivery person terminal 6 will now be described. The delivery person terminal 6 can be a terminal operated by the delivery person delivering the storage box 4. The delivery person terminal 6 is, for example, a portable terminal such as a smartphone or a tablet. In this embodiment, the delivery person terminal 6 is described as a smartphone.

The delivery person terminal 6 includes, for example, a processor 61, a memory 62, a user interface 63, a short-range communication unit 64 (e.g., short-range communicator), and a network interface 65. The processor 61, the memory 62, the user interface 63, the short-range communication unit 64, and the network interface 65 are contained in a housing, not illustrated.

The processor 61 can be an arithmetic element that executes arithmetic processing (e.g., a CPU). The processor 61 can perform various kinds of processing, based on data of a program or the like stored in the memory 62. The processor 61 can execute a program stored in the memory 62 and thus functions as a control unit that can execute various operations.

The memory 62 can be a memory device that stores a program and data used for the program, and the like. The memory 62 can also temporarily store data that is currently being processed by the processor 61. The memory 62 can be configured as a non-volatile memory and a volatile memory.

The user interface 63 can include a display and an operation interface, which is not illustrated. The display can display a screen according to a video signal that is input from the processor 61. For example, the display can display a screen for entering user information for user authentication in the printed object delivery system 1. The operation interface can provide an operation signal corresponding to an operation of an operation member to the processor 61. The operation member is, for example, a touch sensor, a microphone, a numeric keypad, various function keys, or a keyboard or the like. The touch sensor is, for example, a resistive touch sensor or a capacitive touch sensor or the like. The touch sensor can acquire information indicating a position designated in a given area. The touch sensor can be configured as a touch panel integrated with a display and thus inputs a signal indicating a position touched on the screen displayed on the display, to a system controller.

The short-range communication unit 64 can be an interface for communicating with the storage box 4.

The network interface 65 can be an interface for communicating with the server 5 via a network.

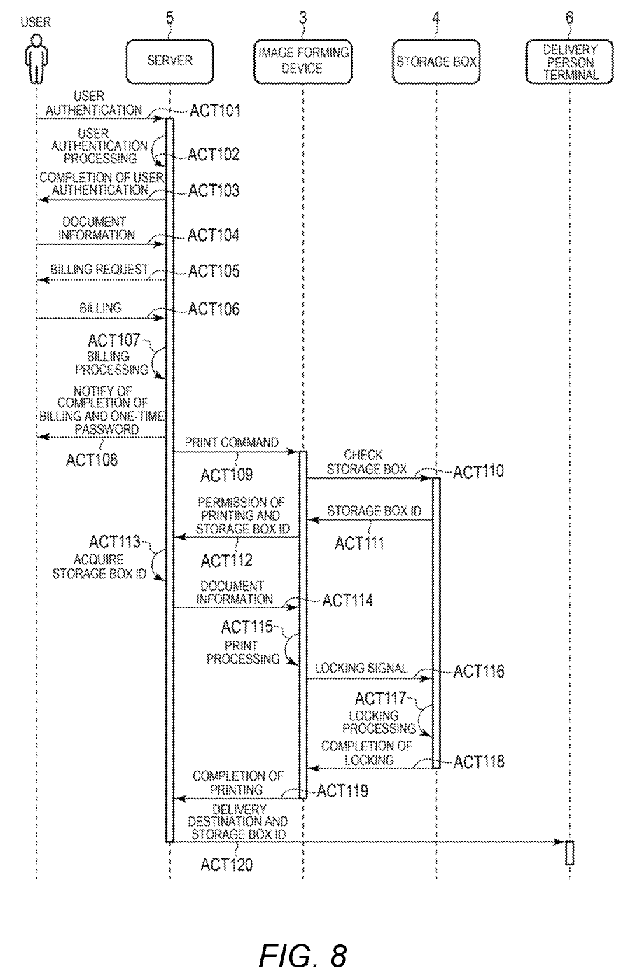

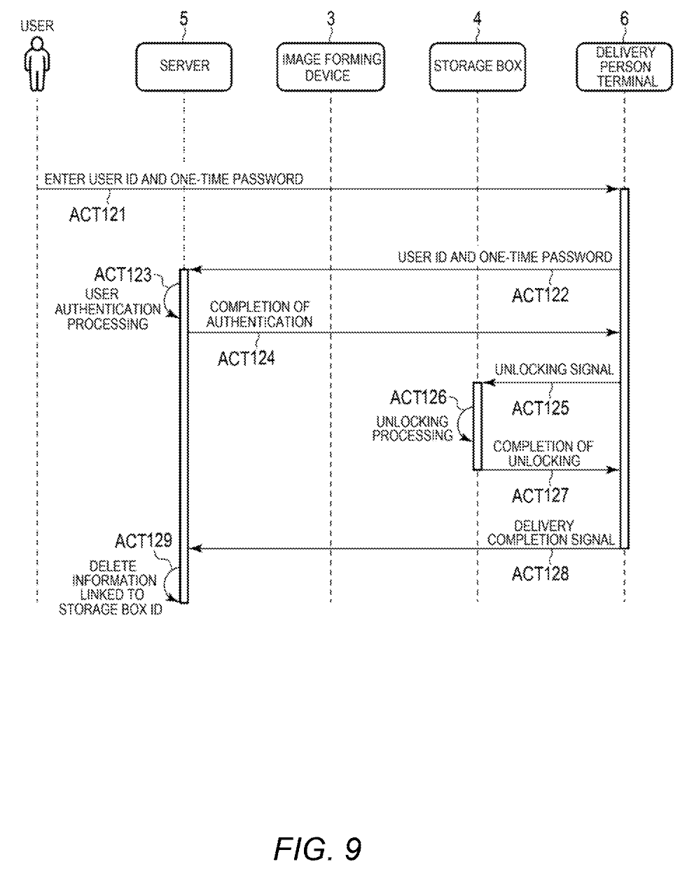

FIGS. 8 and 9 show an outline of a printed object delivery flow in the printed object delivery system 1.

The user first can request the server 5 to perform user authentication (ACT101). The request for user authentication can include a user ID and a login password. The server 5 can authenticate the user, based on the user ID and the login password that are supplied (ACT102), and transmit a signal indicating that the user is authenticated, to the user terminal 2 (ACT103).

The user can transmit document information of a document to be printed, to the server 5 (ACT104). The user may also set information of a delivery destination of a printed object and information of a request destination for printing. The delivery destination and the request destination may be selectively set from information based on the user information database 524 or may be manually input.

The server 5 can check the document information and transmit a billing request to the user if there is no problem (ACT105). The user can transmit information for billing processing, based on the billing request (ACT106). The server 5 can perform billing processing, based on the input from the user (ACT107).

Upon completion of the billing processing, the server 5 can generate a request number and a one-time password, and add the request number, the user ID, the document information, the delivery destination, the request destination, and the one-time password to the request information storage unit 527 (e.g., request information storage). In response to a delivery destination and a request destination not being set in ACT104, the user information database 524 is referred to and the basic delivery destination and the basic request destination can be added to the request information storage unit 527 as the delivery destination and the request destination. Then, at least the one-time password can be transmitted to the user terminal 2, along with a signal indicating that the billing processing is completed (ACT108). In the information stored in the request information storage unit 527, the information about the present request transmitted to the user terminal 2 of the present user may not be limited to the one-time password.

Subsequently, the server 5 can refer to the image forming device information database 525 and transmit a print command to one image forming device 3 having an image forming device ID indicating that the place of installation coincides with the request destination (ACT109). The image forming device 3 can check whether the joining part 36 is joined to the storage box 4, based on the detection by the joining part sensor 37 (ACT110), and if the storage box 4 is joined thereto, the image forming device 3 can acquire the storage box ID from the storage box 4 via the short-range communication unit 38 (ACT111). Upon acquiring the storage box ID, the image forming device 3 can transmit the storage box ID to the server 5, along with a signal indicating that printing is permitted (ACT112).

If the image forming device 3 is in a state of being unable to print or if the storage box 4 is not joined to the image forming device 3, the image forming device 3 can transmit a signal indicating that printing is rejected, to the server 5. If the server 5 receives the signal indicating that printing is rejected, the server 5 can transmit a print command to another image forming device 3 whose place of installation coincides with the request destination. Alternatively, the server 5 may request the image forming device 3 to stack a response to the print command, until the image forming device 3 is enabled to print and the storage box 4 is joined to the image forming device 3.

Upon receiving the storage box ID from the image forming device 3, the server 5 can add the storage box ID to the request information storage unit 527 (ACT113). The server 5 can then transmit the document information to the image forming device 3 (ACT114). Upon receiving the document information, the image forming device 3 can perform print processing to form an image on a print medium, based on the document information (ACT115). At this time, the print medium can be conveyed by the conveying unit 351 of the image forming device 3 and can be stored in the storage box 4 joined to the image forming device 3. Upon completion of the print processing, the image forming device 3 can transmit a locking signal including the storage box ID to the storage box 4 via the short-range communication unit 38 (ACT116). Upon receiving the locking signal, the storage box 4 can compare the storage box ID included in the locking signal with the storage box ID stored in the memory 43, and if the storage box IDs coincide with each other, the storage box 4 can perform locking processing to lock the storage box by the locking mechanism 41 (ACT117). Upon completion of the locking, the storage box 4 can transmit a signal indicating that the locking is completed, to the image forming device 3 via the short-range communication unit 38 (ACT118). Upon receiving the signal indicating the completion of the locking from the storage box 4, the image forming device 3 can transmit a signal indicating that the printing is completed, to the server 5 (ACT119).

Upon receiving the signal indicating the completion of the printing from the image forming device 3, the server 5 can refer to the image forming device information database 525 and transmit at least the storage box ID and the delivery destination stored in the request information storage unit 527 as a delivery request to one delivery person terminal 6 having a delivery person terminal ID registered as linked to the image forming device ID of this image forming device 3 (ACT120). The delivery request can include the request number, and the image forming device ID and the place of installation of the image forming device 3 that performs this printing.

The delivery person can collate the storage box ID included in the delivery request transmitted to the delivery person terminal 6 with the storage box ID imprinted on the housing of the storage box 4 and thus specify the corresponding storage box 4. The delivery person can deliver the corresponding storage box 4 to the delivery destination included in the delivery request.

The user can enter the user ID and the one-time password to the delivery person terminal 6 of the delivery person delivering the storage box 4 (ACT121). The delivery person terminal 6 can request the server 5 to perform user authentication including the user ID and the one-time password that are entered (ACT122). The server 5 can refer to the request information storage unit 527 and authenticates the user, based on the user ID and the one-time password that are supplied (ACT123), and transmit a signal indicating that the user is authenticated, to the delivery person terminal 6 (ACT124). The signal indicating the completion of the user authentication can include the storage box ID.

In some embodiments, the user authentication can be performed using the user ID and the one-time password, but the keys used for the user authentication are not limited to this combination. For example, a combination of the storage box ID and the one-time password, a combination of the request number and the one-time password, or the like, may be employed. Also, the user ID and the login password may be entered to the delivery person terminal 6, and the user authentication may be performed with reference to the user information database 524. Also, only one key may suffice as long as the user authentication can be performed. The keys used for the user authentication in ACTs 121 to 124 can include at least one or more pieces of information that are not disclosed to the delivery person.

Upon receiving the signal indicating the completion of the user authentication from the server 5, the delivery person terminal 6 can transmit an unlocking signal including the storage box ID to the storage box 4 via the short-range communication unit 64 (ACT125). Upon receiving the unlocking signal, the storage box 4 can compare the storage box ID included in the unlocking signal with the storage box ID stored in the memory 43, and if the storage box IDs coincide with each other, the storage box 4 performs unlocking processing to unlock the unboxing opening 402 by the locking mechanism 41 (ACT126). Upon completion of the unlocking, the storage box 4 can transmit a signal indicating that the unlocking is completed, to the delivery person terminal 6 via the short-range communication unit 44 (ACT127).

Upon receiving the signal indicating the completion of the unlocking from the storage box 4, the delivery person terminal 6 can transmit a signal indicating that the delivery of the storage box 4 is completed, to the server 5 (ACT128). The signal indicating the completion of the delivery can include the storage box ID. Upon receiving the signal indicating the completion of the delivery, the server 5 can delete the storage box ID included in the signal indicating the completion of the delivery and the information linked to the storage box ID from the request information storage unit 527 (ACT129).

As described above, the server 5 in the printed object delivery system 1 can acquire user information from the user terminal 2, acquire document information from the user terminal 2, transmit a password to the user terminal 2, acquire storage box information about the storage box 4 from the image forming device 3, request the image forming device 3 to perform printing based on the document information, receive a signal indicating the completion of the printing from the image forming device 3, and subsequently transmit delivery destination information based on the user information, and the storage box information, to the delivery person terminal 6. The storage box 4 can store a printed object printed by the image forming device 3, includes the locking mechanism 41 for locking the storage box 4, and is attachable to and detachable from the image forming device 3. Thus, the server 5 can be provided which implements the printed object delivery system 1 securing the confidentiality of a printed object such that the storage box 4 storing a printed object desired by the user and including the locking mechanism 41 is delivered to the user.

In some embodiments, there may be a case where a first user delivers a printed object to a second user. In such cases, the first user may set an address where the second user can receive the printed object, as the delivery destination, and may notify the second user of a one-time password via email or the like. The second user can unlock the delivered storage box 4, using the one-time password which the second user is notified of.

In some embodiments, a short-range communication unit (e.g., short-range communicator) for communicating with the storage box 4 may be provided in the user terminal 2. As the short-range communication unit is provided in the user terminal 2, the delivery person can deliver the storage box 4 in the form of drop-off delivery even if the user is out and not present at the delivery destination, and the user can unlock the delivered storage box 4, using a password.

While a certain embodiment has been described, the embodiment has been presented by way of example only, and is not intended to limit the scope of the disclosure. Indeed, the novel embodiment described herein may be embodied in a variety of other forms; furthermore, various omissions, substitutions and changes in the form of the embodiment described herein may be made without departing from the spirit of the disclosure. The accompanying claims and their equivalents are intended to cover such forms or modifications as would fall within the scope and spirit of the disclosure.

What is claimed is:

1. A printed object delivery system server comprising:
a communication interface configured to communicate with a first terminal, a second terminal, and an image forming device; and
a processor configured to:
acquire user information from the first terminal,
acquire document information from the first terminal,
acquire storage box information about a storage box from the image forming device, the storage box storing a printed object printed by the image forming device, the storage box comprising a locking mechanism for locking the storage box, the storage box being attachable to and detachable from the image forming device,
request the image forming device to perform printing based on the document information, and
transmit delivery destination information, based on the user information and the storage box information, to the second terminal after receiving a signal indicating completion of printing from the image forming device.

2. The server according to claim 1, wherein the processor:
receives a key from the second terminal and performs authentication processing to authenticate a user based on the key received from the second terminal, and
transmits a signal for unlocking the locking mechanism of the storage box to the second terminal if the user is authenticated by the authentication processing.

3. The server according to claim 2, wherein:
the key is a password, and
the processor:
transmits the password to the first terminal,
receives the password from the second terminal, and performs authentication processing to authenticate a user based on the password received from the second terminal, and
transmits a signal for unlocking the locking mechanism of the storage box to the second terminal if the user is authenticated by the authentication processing.

4. A printed object delivery system comprising a server, a storage box, and an image forming device configured to communicate with the server and the storage box,
the server comprising:
a first communication interface configured to communicate with a first terminal, a second terminal, and the image forming device; and
a first processor configured to:
acquire user information from the first terminal,
acquire document information from the first terminal,
acquire storage box information about the storage box from the image forming device,
request the image forming device to perform printing based on the document information, and
transmit delivery destination information, based on the user information and the storage box information, to the second terminal after receiving a signal indicating completion of printing from the image forming device,
the image forming device comprising:
a second communication interface configured to communicate with the server and the storage box; and
a second processor configured to:
request the storage box to provide the storage box information, and transmit the acquired storage box information to the server,
perform printing in response to a print request based on the document information from the server, and
transmit the signal indicating the completion of the printing to the server if the printing is completed,
the storage box storing a printed object printed by the image forming device and being attachable to and detachable from the image forming device, and
the storage box comprising:
a locking mechanism for locking the storage box;
a third communication interface configured to communicate with the image forming device;
a memory configured to store the storage box information; and
a third processor configured to transmit the storage box information stored in the memory to the image forming device in response to a request for the storage box information from the image forming device.

5. The system according to claim 4, wherein the first processor:
receives a key from the second terminal, and performs authentication processing to authenticate a user based on the key received from the second terminal, and
transmits a signal for unlocking the locking mechanism of the storage box to the second terminal if the user is authenticated by the authentication processing.

6. The system according to claim 5, wherein:
the key is a password, and
the first processor:
transmits the password to the first terminal,
receives the password from the second terminal, and performs authentication processing to authenticate a user based on the password received from the second terminal, and
transmits a signal for unlocking the locking mechanism of the storage box to the second terminal if the user is authenticated by the authentication processing.

7. A control method for a printed object delivery system server, comprising:
acquiring, by one or more processors, user information from a first terminal;
acquiring, by the one or more processors, document information from the first terminal;
acquiring, by the one or more processors, storage box information about a storage box, the storage box storing a printed object printed by an image forming device, the storage box comprising a locking mechanism for locking the storage box, the storage box being attachable to and detachable from the image forming device;
requesting, by the one or more processors, the image forming device to perform printing based on the document information; and
transmitting, by the one or more processors, delivery destination information, based on the user information and the storage box information, to a second terminal after receiving a signal indicating completion of printing from the image forming device.

8. The method according to claim 7, further comprising:
receiving, by the one or more processors a key from the second terminal, and performs authentication processing to authenticate a user based on the key received from the second terminal, and
transmitting, by the one or more processors, a signal for unlocking the locking mechanism of the storage box to the second terminal if the user is authenticated by the authentication processing.

9. The method according to claim 8, wherein
the key is a password, and
the method further comprises:
transmitting, by the one or more processors, the password to the first terminal,
receiving, by the one or more processors, the password from the second terminal, and performs authentication processing to authenticate a user based on the password received from the second terminal, and
transmitting, by the one or more processors, a signal for unlocking the locking mechanism of the storage box to the second terminal if the user is authenticated by the authentication processing.
